(19) United States
(12) Patent Application Publication
(10) Pub. No.: US 2013/0333785 A1
(43) Pub. Date: Dec. 19, 2013

(54) HYDRAULIC ACCUMULATOR DEVICE

(71) Applicants: Andreas Vogt, Renningen (DE); Peter Schmuttermair, Gessertshausen (DE); Ralph Engelberg, Ditzingen (DE); lngo Bork, Lohr (DE)

(72) Inventors: Andreas Vogt, Renningen (DE); Peter Schmuttermair, Gessertshausen (DE); Ralph Engelberg, Ditzingen (DE); lngo Bork, Lohr (DE)

(73) Assignee: ROBERT BOSCH GMBH, Stuttgart (DE)

(21) Appl. No.: 13/992,973

(22) PCT Filed: Dec. 5, 2011
(86) PCT No.: PCT/EP11/71691

§ 371 Date: Sep. 3, 2013

(30) Foreign Application Priority Data
Dec. 9, 2010 (DE) 10 2010 062 693.7

(51) Int. Cl. F15B 1/04

(52) U.S. Cl. CPC F15B 1/04
USPC 138/30

(57) ABSTRACT

The invention relates to a hydraulic accumulator device in the form of a membrane accumulator, comprising a membrane (16) which separates a pneumatic volume from a hydraulic volume. In order to improve said hydraulic accumulator device with respect to the degree of efficiency and/or manufacturing costs, the membrane (16) is tensioned between two holding bodies (4,5) which respectively comprise several recesses (11-14) and between which the membrane (16) is tensioned in order to produce several hydropneumatic membrane accumulators.

### BACKGROUND OF THE INVENTION

The invention relates to a hydraulic accumulator device constructed as a diaphragm accumulator, having a diaphragm which separates a pneumatic volume from a hydraulic volume.

### SUMMARY OF THE INVENTION

It is an object of the invention to improve a hydraulic accumulator device constructed as a diaphragm accumulator, having a diaphragm which separates a pneumatic volume from a hydraulic volume, with regard to its efficiency and/or its production costs.

The object is achieved, in the case of a hydraulic accumulator device constructed as a diaphragm accumulator, having a diaphragm which separates a pneumatic volume from a hydraulic volume, in that the diaphragm is clamped between two holding bodies which have in each case a plurality of depressions and between which the diaphragm is clamped in order to form a plurality of hydropneumatic diaphragm accumulators. The holding bodies are preferably of plate-like form. One of the holding bodies delimits a plurality of pneumatic volumes. The other holding body delimits a plurality of hydraulic volumes. By means of the hydraulic accumulator device according to the invention, it is possible in a simple manner for a hydraulic accumulator field having a multiplicity of hydropneumatic diaphragm accumulators to be realized. In the hydraulic accumulator device according to the invention, it is also possible in a simple manner for a plurality of hydraulic accumulator fields to be combined with one another. The shape and the size of the hydraulic accumulator fields can be adapted in a simple manner to a given installation space.

A preferred exemplary embodiment of the hydraulic accumulator device is characterized in that the depressions of the holding bodies face toward one another in pairs in order to form in each case one hydropneumatic diaphragm accumulator. The depressions of one holding body delimit a multiplicity of hydraulic volumes. The depressions of the other holding body delimit a multiplicity of pneumatic volumes. The hydraulic volumes and pneumatic volumes are assigned to one another in pairs and are separated from one another by the diaphragm. This yields, with few components, a multiplicity of diaphragm accumulators.

A further preferred exemplary embodiment of the hydraulic accumulator device is characterized in that the holding bodies are connected to one another between the depressions. The holding bodies preferably bear areally against one another between the depressions. In said areal regions, the holding bodies are connected to one another at least in punctiform fashion for example by means of fastening elements.

A further preferred exemplary embodiment of the hydraulic accumulator device is characterized in that the depressions have the shape of spherical segments or combs. The spherical segments or combs are outwardly bulged. The combs have for example a hexagonal cross section in the manner of honeycombs.

A further preferred exemplary embodiment of the hydraulic accumulator device is characterized in that the holding bodies have in each case at least one connector, and/or in that the depressions assigned to in each case one of the holding bodies are fluidically connected to one another. The connector may comprise for example a pneumatic connector duct or a hydraulic connector duct. The individual depressions may be hydraulically or pneumatically connected to one another. The connector ducts may be formed for example by sickle-shaped deformations of the holding bodies.

A further preferred exemplary embodiment of the hydraulic accumulator device is characterized in that, in the holding bodies, there are formed connecting ducts by means of which depressions assigned to in each case one of the holding bodies are fluidically connected to one another. The connecting ducts may, in a simple manner, be formed by sickle-shaped deformations of the holding bodies.

A further preferred exemplary embodiment of the hydraulic accumulator device is characterized in that the diaphragm is pre-shaped, reinforced and/or supported in the region of the connecting ducts and/or of the depressions. The diaphragm may for example be supported by supporting rings. On the supporting rings there may be formed supporting collars, the shape of which is adapted to the shape of the depressions.

A further preferred exemplary embodiment of the hydraulic accumulator device is characterized in that a plurality of hydraulic accumulator fields which comprise in each case two holding bodies and one diaphragm are mechanically and/or fluidically coupled to one another. The mechanical coupling of the hydraulic accumulator fields may be realized for example by means of tie rods. The fluidic coupling of the hydraulic accumulator fields may be realized for example by means of correspondingly designed coupling elements and/or lines.

A further preferred exemplary embodiment of the hydraulic accumulator device is characterized in that the holding bodies are provided as plate-like main bodies with the depressions. The holding bodies with the plate-like main bodies may be formed from a deep-drawn or stamped sheet-metal material. The holding bodies with the plate-like main bodies may also be formed from a laminated fiber-composite plastics material. The holding bodies may for example be formed as CFRP plates. The abbreviation CFRP stands for a Carbon Fiber Reinforced Plastic composite, that is to say a plastics material reinforced with carbon fibers.

A further preferred exemplary embodiment of the hydraulic accumulator device is characterized in that suitable support rings are inlaid in the region of the depressions, and/or in that the hydropneumatic diaphragm accumulators are clamped by means of tie rods between two supporting plates.

A further preferred exemplary embodiment of the hydraulic accumulator device is characterized in that, instead of one continuous diaphragm, a plurality of individual diaphragms are used.

A further preferred exemplary embodiment of the hydraulic accumulator device is characterized in that support rings are formed into the diaphragm.

A further preferred exemplary embodiment of the hydraulic accumulator device is characterized in that the diaphragm simultaneously performs the function of a seal between the holding bodies.

The invention also relates to the use of an above-described hydraulic accumulator device as a load-bearing structural component.

The invention also relates to a diaphragm and/or a holding body for a hydraulic accumulator device as described above.

The hydraulic accumulator device according to the invention is particularly suitable for mobile hydraulic applications, in particular for motor vehicles with a hydraulic traction drive and for hydraulic hybrid vehicles. By means of the design according to the invention of the hydraulic accumulator device, the integration thereof into a motor vehicle is simplified. The hydraulic accumulator device may be used as a load-bearing component, for example as a floor plate. The vehicle structure can be stiffened in this way.

The design according to the invention of the hydraulic accumulator device provides inter alia the advantage that a plurality of individual accumulators can be produced in a simple manner in only one manufacturing step. As a result of the special design and arrangement of the holding bodies and of the diaphragm, it is possible for a hydraulic accumulator device having a plurality of hydropneumatic diaphragm accumulators to be produced from only three simple components. The holding bodies and the diaphragm can be produced in a simple and inexpensive manner. By storing a plurality of storage fields one above the other or adjacent to one another, the hydraulic accumulator device according to the invention can be adapted in a simple manner to a predefined installation space. The depressions in the holding bodies are formed preferably by domed formations with relatively small radii. This provides the advantage that relatively thin-walled materials can be used to produce the holding bodies, which has a positive effect on the weight and the material costs of the hydraulic accumulator device.

Further advantages, features and details of the invention will emerge from the following description, in which various exemplary embodiments are described in detail with reference to the drawing.

### BRIEF DESCRIPTION OF THE DRAWINGS

In the drawing:

FIG. 1 is a simplified illustration of a hydraulic accumulator device according to the invention in section;

FIG. 2 shows a corner of the hydraulic accumulator device from FIG. 1, in a plan view;

FIG. 3 shows a similar hydraulic accumulator device to that in FIG. 2 with connecting ducts, in a plan view;

FIG. 4 shows a detail from FIG. 3 in section (FIG. 4a) and in a plan view (FIG. 4b);

FIG. 5 shows a detail from FIG. 1 in section (FIG. 5a) and in a plan view (FIG. 5b), with a connecting duct formed as a bead;

FIG. 6 shows a detail from FIG. 1 with a supporting ring;

FIG. 7 shows the detail from FIG. 6 in a plan view;

FIG. 8 shows a similar illustration to FIG. 6, with a modified supporting ring;

FIG. 9 shows the detail from FIG. 8 in a plan view;

FIG. 10 shows a similar illustration to FIG. 8, with a pre-shaped diaphragm;

FIG. 10a shows a similar illustration to FIG. 8, as per a further exemplary embodiment;

FIG. 11 shows a detail of a hydraulic accumulator device having two hydraulic accumulator fields coupled to one another, in a plan view;

FIG. 12 shows a hydraulic accumulator field from FIG. 11 with a connected line;

FIG. 13 shows a detail of a hydraulic accumulator device with three hydraulic accumulator fields coupled to one another, in section;

FIG. 14 shows an arrangement, optimized with regard to installation space and forces, of two hydraulic accumulator fields one above the other; and

FIG. 15 shows a hydraulic accumulator device having a plurality of hydraulic accumulator fields which are connected to one another by means of tie rods.

### DETAILED DESCRIPTION

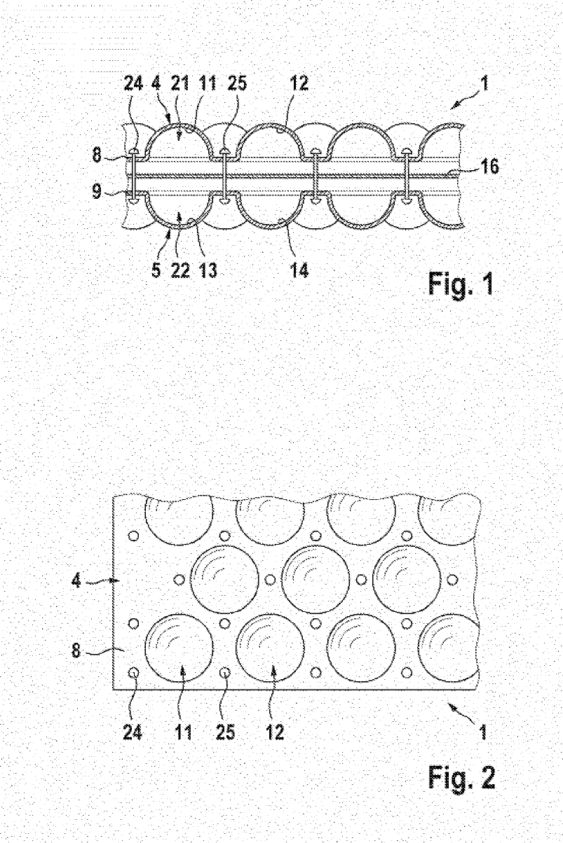

FIGS. 1 and 2 illustrate a detail of a hydraulic accumulator device 1 according to the invention in different views. The hydraulic accumulator device 1 comprises two holding bodies 4, 5 which are formed in each case from a substantially plate-like main body 8, 9. The two plate-like main bodies 8, 9 are equipped with hemispherical depressions 11, 12; 13, 14, in a manner similar to a baking tray for cakes, in particular muffins. The holding bodies 4, 5 are formed for example from a sheet-metal material. The plate-like main bodies 8, 9 are outwardly bulged in the region of the depressions 11, 12; 13, 14 such that the depressions 11, 12 and 13, 14 of the two holding bodies 4, 5 face toward one another.

Each holding body 4, 5 is equipped with a multiplicity of depressions 11, 12; 13, 14. It can be seen in FIG. 2 that the depressions 11, 12 are distributed uniformly over the plate-like main body 8. It can be seen in FIG. 1 that in each case two mutually opposite depressions 11, 13 and 12, 14 delimit in each case one substantially spherical volume.

A diaphragm 16 is clamped between the holding bodies 4, 5 such that the volumes enclosed by the depressions 11, 12 and 13, 14 are divided in each case into a pneumatic volume 21 and a hydraulic volume 22. The pneumatic volume 21, like the hydraulic volume 22, has substantially the shape of a hemisphere owing to the shape of the depressions 11 and 13.

The two holding bodies 4, 5 are fastened to one another, with the interposition of the diaphragm 16, by means of fastening elements 24, 25. The fastening elements 24, 25 extend through the plate-like main bodies 8, 9 and the diaphragm 16 perpendicular to the components 8, 9 and 16. Here, the fastening elements 24, 25 are arranged not in the region of the depressions 11 to 14 but rather between these.

The fastening elements 24, 25 may for example comprise rivet connection elements or screw connection elements. Alternatively or in addition, the holding bodies 4, 5 may be connected to one another in punctiform fashion in a cohesive manner, for example by adhesive bonding or welding. The diaphragm 16 is interrupted, or provided with a through hole, in the region of the connection between the holding bodies 4, 5.

The pneumatic volumes 21 of the hydraulic accumulator device 1 are filled with a pneumatic medium, such as gas, during operation. The hydraulic volumes 22 of the hydraulic accumulate device 1 are filled with a hydraulic medium, such as oil, during operation. To be filled, the individual pneumatic volumes 21 and hydraulic volumes 22 at the oil and gas sides must be connected to one another and, via connectors, to the outside.

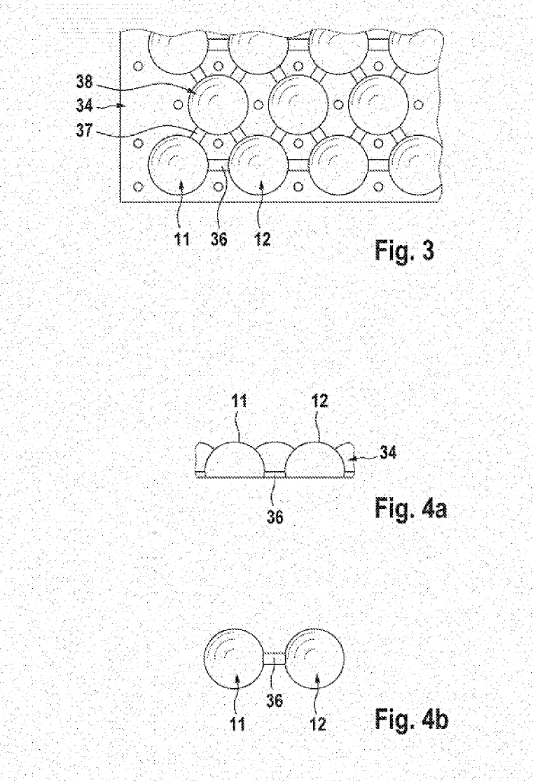

FIGS. 3 and 4 illustrate, on the basis of the example of a holding body 34, that the depressions 11, 12 or the pneumatic volumes enclosed by the depressions 11, 12 and the diaphragm are fluidically, that is to say pneumatically, connected to one another by a connecting duct 36. The pneumatic volume delimited by the depression 11 is connected to a pneumatic volume delimited by a depression 38 by a further connecting duct 37.

It can be seen in FIG. 3 that the connecting ducts 36, 37 are arranged in a uniformly distributed manner between the pneumatic volumes. The holding body 5 which serves for delimiting the hydraulic volumes is preferably of the same design as the holding body 34 with the pneumatic volumes. According to a further aspect of the invention, connecting ducts of the hydraulic volumes may be arranged offset with respect to connecting ducts of the pneumatic volumes so as not to impair the stability of the holding bodies.

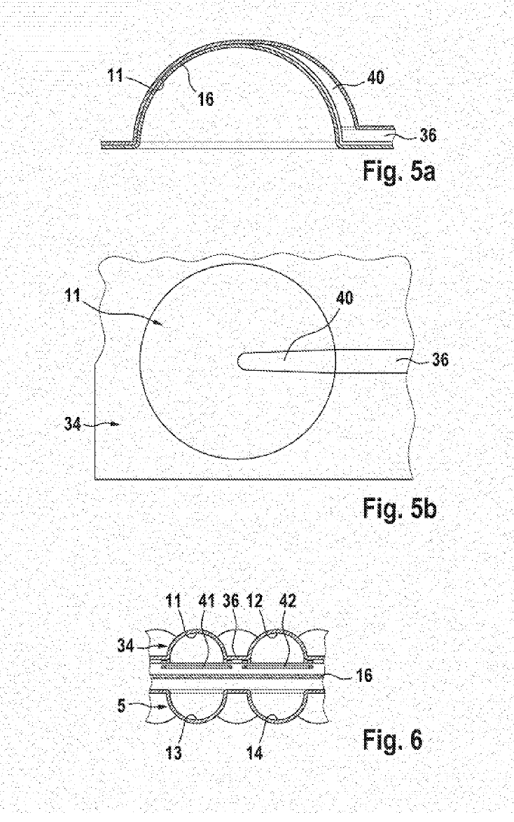

It is indicated in FIG. 5 that the inflow and outflow into and out of the pneumatic volume of the depression 11 can be optimized by virtue of the connecting duct 36 being continued in a bead 40.

In FIG. 5, the diaphragm 16 is illustrated in a state in which it bears at the inside against the depression 11. In the region of the connecting duct 36 or of the bead 40, the diaphragm 16 may be clamped in a non-optimum manner between the holding bodies.

FIGS. 6 to 9 show how the clamping of the diaphragm 16 between the holding bodies 34 and 5 can be improved through the use of supporting rings 41, 42; 45, 46.

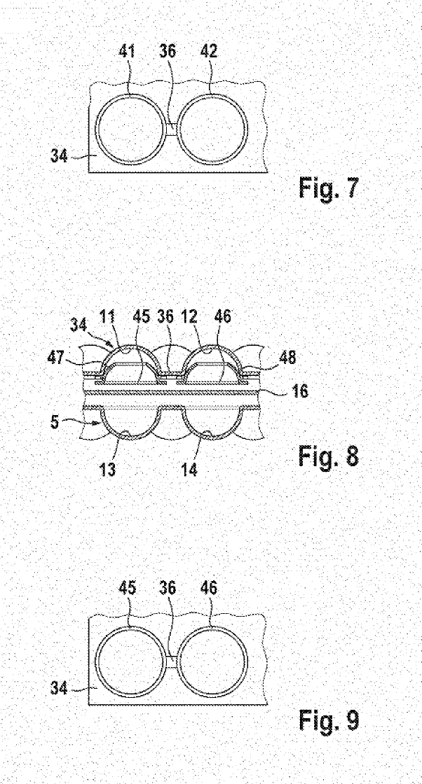

In the exemplary embodiment illustrated in FIGS. 6 and 7, the supporting rings 41, 42 are designed as simple rings, the diameter of which corresponds to the diameter of the depressions 11, 12. The supporting rings 41, 42 prevent the diaphragm 16 from deforming into the connecting duct 36.

In the exemplary embodiment illustrated in FIGS. 8 and 9, the supporting rings 45, 46 are additionally provided with a supporting collar 47, 48 which extends into the depression 11, 12. The design of the collars 47, 48 is adapted to the design of the associated depression 11, 12. The supporting collar 47, 48 prevents the diaphragm 16 from deforming into a bead, as denoted by 40 in FIG. 5.

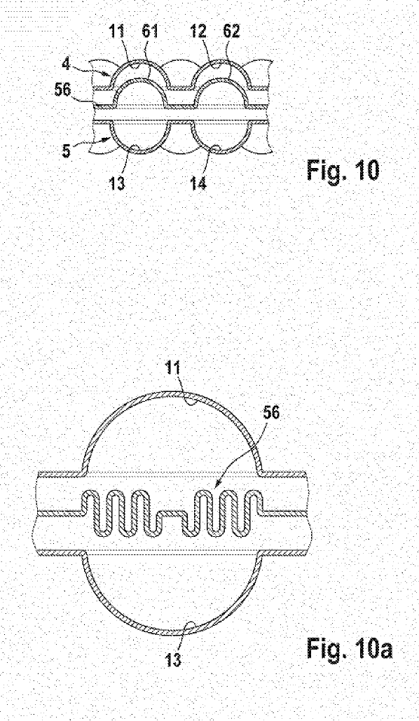

It is indicated in FIG. 10 that the diaphragm need not imperatively have a planar form. In FIG. 10, there is clamped between the holding bodies 4, 5 a diaphragm 56 which comprises pre-shaped regions 61, 62 in the region of the depressions 11, 12. The pre-shaped regions 61, 62 have the shape of a hemisphere which is adapted to the shape of the depression 11, 12. Further forms such as for example that shown in FIG. 10a are also possible.

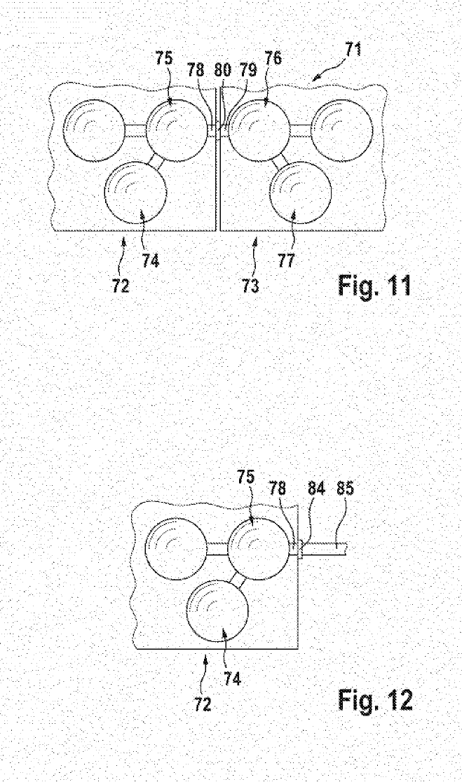

FIG. 11 shows that, in a hydraulic accumulator device 71 according to the invention, two or more hydraulic accumulator fields 72, 73 can be combined with one another in a simple manner. Each hydraulic accumulator field 72; 73 comprises a multiplicity of hydropneumatic diaphragm accumulators 74, 75; 76, 77. The two hydraulic accumulator fields 72, 73 are fluidically coupled to one another by means of a coupling element 80. The coupling element 80 connects two connector ducts 78, 79 to one another. The connector duct 78 extends from a pneumatic volume or a hydraulic volume of the hydropneumatic diaphragm accumulator 75. The connector duct 79 extends from a pneumatic volume or hydraulic volume of the hydropneumatic diaphragm accumulator 76.

It is shown in FIG. 12 that a line 85 may also be connected to the connector duct 78 of the hydraulic accumulator field 72 by means of a coupling element 84. The line 85 may be in the form of a hydraulic line or pneumatic line.

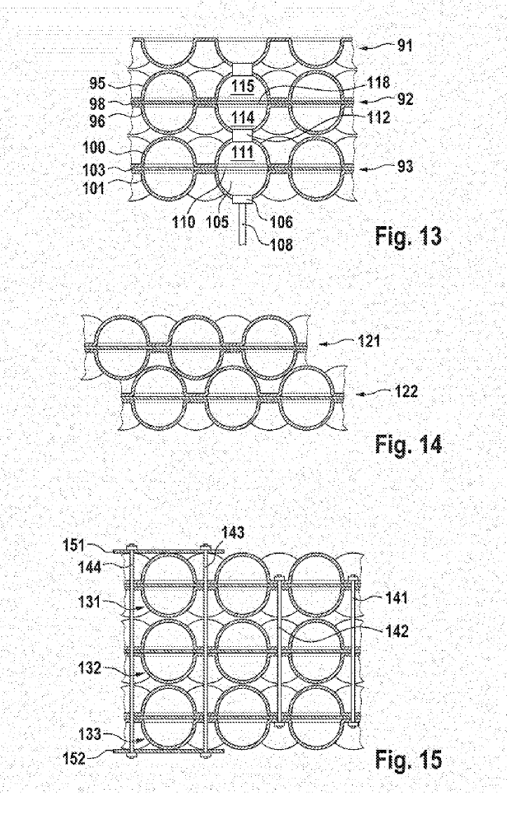

It is indicated in FIG. 13 that, in a hydraulic accumulator device according to the invention, two or more hydropneumatic accumulator fields 91, 92, 93 may also be arranged one above the other. In this arrangement of the accumulator fields 91 to 93 one above the other, it is possible for the otherwise unutilized volumes between the individual accumulators to advantageously be utilized as a low-pressure volume. The low-pressure volume may for example be filled with a hydraulic medium which is at low pressure.

In FIG. 13, the accumulator field 92 comprises two holding bodies 95, 96, between which a diaphragm 98 is clamped. The accumulator field 93 comprises two holding bodies 100, 101, between which a diaphragm 103 is clamped. In the region of a depression 105 of the holding body 101, a line 108 is connected to the illustrated hydraulic accumulator device by means of a coupling element 106. According to a further aspect of the invention, the diaphragm 103 is provided with a through hole 110 which connects the volume in the depression 105 to the volume in a depression 111 of the holding body 100. The volume enclosed by the depression 111 is connected via a further coupling element 112 to a volume 114 of the holding body 96. The volume 114 is in turn connected via a through hole 118 to a volume 115 of the holding body 95.

It is shown in FIG. 14 that, in the case of an arrangement of two accumulator fields 121, 122 one above the other, an existing installation space can be optimally utilized by virtue of the accumulator fields 121, 122 being arranged offset relative to one another. In the case of the offset arrangement, the hemispheres, formed by the depressions, of the holding bodies can be supported on one another in punctiform fashion. As a result of the stabilization associated with this, the wall thickness of the holding bodies can be reduced. In connection with the offset arrangement of the accumulator fields 121, 122, a comb-shaped form of the depressions has proven to be particularly advantageous.

FIG. 15 illustrates how three accumulator fields 131 to 133 arranged one above the other can be mechanically coupled to one another in a particularly stable manner by means of tie rods 141 to 144. The tie rods 141 and 142 extend between the holding bodies of the accumulator fields 131 and 133. The tie rods 143, 144 extend between two supporting plates 151, 152 between which the three accumulator fields 131 to 133 are clamped.

The combinations, illustrated in FIGS. 13 to 15, of a plurality of accumulator fields in a hydraulic accumulator device according to the invention permit a considerably higher rigidity than a flat plate of the same material. This effect can be even further intensified under pressure. In this way, it is possible for the hydraulic accumulator device according to the invention to be utilized as a load-bearing structure, for example in a motor vehicle. The hydraulic accumulator device may be used as a vehicle floor or as some other structural component in a motor vehicle.

1. A hydraulic accumulator device constructed as a diaphragm accumulator, having a diaphragm (16) which separates a pneumatic volume from a hydraulic volume, characterized in that the diaphragm (16) is clamped between two holding bodies (4, 5; 34) which have in each case a plurality of depressions (11-14) and between which the diaphragm (16; 56) is clamped in order to form a plurality of hydropneumatic diaphragm accumulators.

2. The hydraulic accumulator device as claimed in claim 1, characterized in that the depressions (11-14) of the holding bodies (4, 5; 34) face toward one another in pairs in order to form in each case one hydropneumatic diaphragm accumulator.

3. The hydraulic accumulator device as claimed in claim 1, characterized in that the holding bodies (4, 5; 34) are connected to one another between the depressions (11-14).

4. The hydraulic accumulator device as claimed in claim 1, characterized in that the depressions (11-14) have the shape of spherical segments or combs.

5. The hydraulic accumulator device as claimed in claim 1, characterized in that the holding bodies (4, 5; 34) have in each case at least one connector, and/or in that the depressions (11-14) assigned to in each case one of the holding bodies (4, 5; 34) are fluidically connected to one another.

6. The hydraulic accumulator device as claimed in claim 1, characterized in that, in the holding bodies (4, 5; 34), there are formed connecting ducts (36, 37) by means of which depressions assigned to in each case one of the holding bodies (4, 5; 34) are fluidically connected to one another.

7. The hydraulic accumulator device as claimed in claim 6, characterized in that the diaphragm (16) is pre-shaped, reinforced and/or supported in the region of the connecting ducts (36, 37) and/or of the depressions (11-14).

8. The hydraulic accumulator device as claimed in claim 1, characterized in that a plurality of hydraulic accumulator fields (71, 72; 91, 92; 131-133) which comprise in each case two holding bodies (4, 5; 34) and one diaphragm (16; 56) are mechanically and/or fluidically coupled to one another.

9. The hydraulic accumulator device as claimed in claim 1, characterized in that the holding bodies (4, 5; 34) are provided as plate-like main bodies (8, 9) with the depressions (11-14).

10. The hydraulic accumulator device as claimed in claim 1, characterized in that suitable support rings (41, 42, 45, 46) are inlaid in the region of the depressions (11-14), and/or in that the hydropneumatic diaphragm accumulators are clamped by means of tie rods (141-144) between two supporting plates.

11. The hydraulic accumulator device as claimed in claim 1, characterized in that, instead of one continuous diaphragm, a plurality of individual diaphragms are used.

12. The hydraulic accumulator device as claimed in claim 1, characterized in that support rings are formed into the diaphragm.

13. The hydraulic accumulator device as claimed in claim 1, characterized in that the diaphragm (16; 56) simultaneously performs the function of a seal between the holding bodies (4, 5; 34).

14. The use of a hydraulic accumulator device (1; 71) as claimed in claim 1 as a load-bearing structural component.

15. A diaphragm (16) and/or holding body (4, 5; 34) for a hydraulic accumulator device (1) as claimed in claim 1.
